(19) United States
(12) Patent Application Publication
(10) Pub. No.: US 2026/0094587 A1
(43) Pub. Date: Apr. 2, 2026

(54) SYSTEM AND METHOD FOR CREATING MUSIC-AWARE VIRTUAL ASSISTANTS

(71) Applicant: Carnegie Mellon University, Pittsburgh, PA (US)

(72) Inventors: Alexander Wang, Pittsburgh, PA (US); David Lindbauer, Pittsburgh, PA (US); Chris Donahue, Pittsburgh, PA (US)

(73) Assignee: Carnegie Mellon University, Pittsburgh, PA (US)

(21) Appl. No.: 19/343,886

(22) Filed: Sep. 29, 2025

Related U.S. Application Data
(60) Provisional application No. 63/700,027, filed on Sep. 27, 2024.

(51) Int. Cl. G10H 1/00; G10L 13/047

(52) U.S. Cl. CPC G10H 1/0025; G10L 13/047

(57) ABSTRACT

A system and method provide musically integrated notifications on a user’s device, such as a phone or laptop. The notifications are received as text-based notifications and converted to speech notifications, which are typically done by virtual assistants running on the device. In the system and method disclosed herein, the speech notification undergoes further processing to match the context of music playing on the user’s device. In addition, the system and method consider the prosody of the notification to increase intelligibility of the musically integrated notification, decreasing the perceived disruption to the user.

### CROSS-REFERENCE TO RELATED APPLICATIONS

This application claims the benefit under 35 U.S.C. § 119 of U.S. Provisional Application Serial No. 63/700,027, filed on September 27, 2024, which is incorporated herein by reference.

### STATEMENT REGARDING FEDERALLY SPONSORED RESEARCH

Not applicable.

### BACKGROUND OF THE INVENTION

The present disclosure generally relates to a system and method for providing notifications to users of digital devices. More specifically, the disclosure relates to a system and method for integrating a notification into musical media being played on the digital device in an unobtrusive manner by providing the notification with a melody and musical voice that closely resembles the media being played.

Spoken notifications provide convenient access to rich information without the need for a screen. Virtual assistants utilized on digital devices such as phones, tablets, laptops, and speakers see prevalent use in hands-free settings such as driving or exercising. Given a text-based notification from an application, these systems use text-to-speech (TTS) to dictate a spoken notification to inform users of new information. In many hands-free settings, users also regularly enjoy listening to music. In such settings, virtual assistants will temporarily mute a user's music and overlay the speech generated from the text-based notification to improve intelligibility of the speech. However, users may perceive these interruptions as intrusive, negatively impacting their music listening experience.

Prior works have attempted to lessen the interruption by integrating ringtones into music, for example. Ringtones, which are short musical composition and lack a spoken component, can be matched to the user’s music through techniques such as timbre transfer and harmonic mixing. While those techniques improved user experience by decreasing the disruptiveness of notifications, they failed to provide the robust information conveyed by spoken notifications.

Other works have used singing voice synthesis (SVS) to convert one singing voice to another with high intelligibility, but they require human singing as input and accordingly are not practical for musical notifications originating with digital assistants. Even if the input problem were overcome, human singing can be hard to understand, posing an obstacle to any setting where intelligibility is of critical importance.

Therefore, it would be advantageous to develop a system and method that integrates a vocal notification into the music being played on a user’s device, while permitting high intelligibility and improved prosody.

### BRIEF SUMMARY

According to embodiments of the present disclosure is a system and method for providing musical notifications. More specifically, the system and method take in text-based notifications and user music as inputs and output musical notifications. Using this approach, the system blends spoken notifications from virtual assistants into music being enjoyed by the user in a less obtrusive manner than current notification systems.

In one embodiment, the output from the system can be integrated into user music by replacing any existing vocals for a blended delivery of information. The system and method incorporate two components that improve the outputs of digital assistants. Specifically, the system comprises (1) a module that employs a process to generate new melodies by adjusting a music transformer to account for music and text prosody, and (2) a module that can segment the syllables in spoken text and map each syllable to a melody note. The system and method improve user experience by ensuring that the output voice messages are intelligible and blend well with the current song, minimizing intrusiveness and interruptions to music listening.

As a result, instead of muting a user's music and overlaying a spoken notification, the system modifies the spoken notifications so that they resemble someone “singing” them in harmony with the song a user is currently listening to. The improvement over prior systems is a more enjoyable music listening experience by making notifications musically aware, thus reducing intrusiveness, improving music fit, and making the experience delightful. In addition, the system complements other modes of notification presentation, as opposed to replacing them. The system can be used to target scenarios when low to medium-urgency messages are delivered in casual listening situations, such as receiving a reminder during an exercise session; or receiving a meeting invitation while going for a walk. During these tasks, the system provides an unobtrusive and lighthearted alternative to turning notifications off.

One major factor for intelligibility in speech is prosody, i.e., the acoustic parameters of speech that shape the sound qualities beyond the textual context. For instance, it is hard to understand the speech of someone who speaks monotonously and stretches syllables to be the same duration. More succinctly, prosody can be considered those phenomena that involve the acoustic parameters of pitch, duration, and intensity. Building on research in music intelligibility, the system aims to make the outputs of musical voice assistants intelligible by assigning messages to a melody that matches the prosody of the original speech. To achieve this, the system will compose melodies that are suitable for the input text.

### BRIEF DESCRIPTION OF THE SEVERAL VIEWS OF THE DRAWINGS

FIG. 1 a diagram showing different components of the system according to one embodiment.

FIG. 2 is a flowchart of the method.

FIG. 3 is a diagram of a pre-processing stage.

FIG. 4 depicts the stretching of the speech to match a melody.

FIG. 5 is a graph showing performance characteristics according to a trial user study.

### DETAILED DESCRIPTION

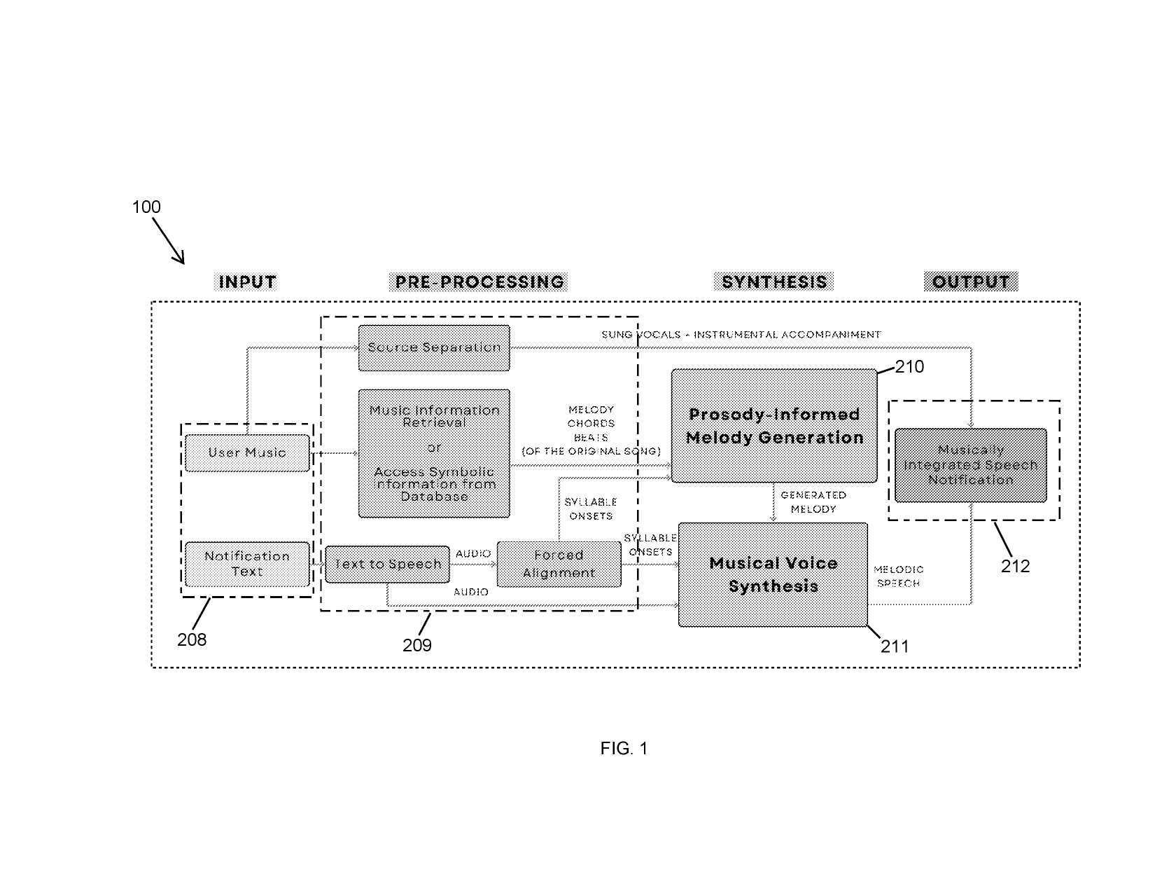

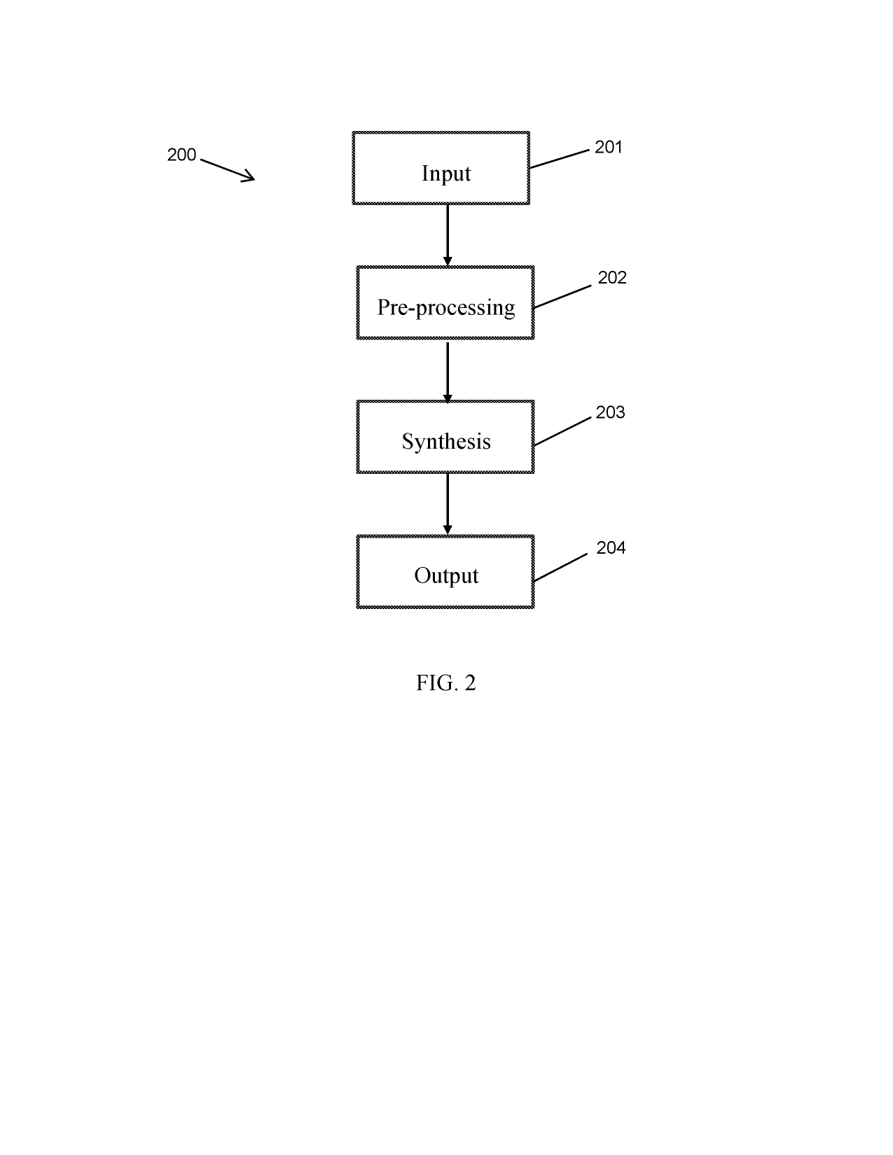

According to embodiments of the disclosure is a system 100 and method 200 for providing musically integrated notifications. The musically integrated notifications are converted from text-based notifications provided by a digital assistant, for example, into speech notifications that match the melody of music playing on a user’s device (i.e. a musically integrated notification). FIG. 1 is a diagram of the system 100, which can be implemented on a phone, laptop, or any device having a digital assistant or is capable of providing notifications to the user. As shown in FIG. 1, the system 100 comprises various modules, including an input module 208, a pre-processing module 209, a melody generation module 210, a musical voice synthesis module 211, and an output module 212, that are configured to perform various processing steps (including the method 200, as shown in FIG. 2) to convert the text-based notification into a musically integrated notification.

The modules can be software or hardware components. In one example embodiment, the system 100 is an application running on a user’s device that also has a virtual assistant, such as SIRI or GOOGLE ASSISTANT. By way of further detail, any module 208/209/210/211/212 and other system components may comprise a controller, a microcomputer, a microprocessor, a microcontroller, an application specific integrated circuit, a programmable logic array, a logic device, an arithmetic logic unit, a digital signal processor, or another data processor and supporting electronic hardware and software.

FIG. 2 is a flowchart showing four basic steps of the method 200 of creating musically integrated notifications, including an input stage 201, a pre-processing stage 202, a synthesis stage 203, and an output stage 204. The method 200 begins at step 201 and may use the various modules of the system 100 (i.e. modules 208/209/210/211/212). During the input stage 201, user music and notification text are received as inputs. Next, during the pre-processing stage 202, user music undergoes source separation to divide the music into sung vocals and instrumental accompaniment components. Further, music information retrieval or symbolic information access is performed to help identify the melody, chords, beats, and general structure of the user music. Also during this stage 202, the notification text is converted to audio. After conversion, the audio-converted text is forced into alignment with the music based on syllable onsets, for example. The syllable onsets will be used in separate processes during the synthesis stage 203.

Once the pre-processing stage 202 is completed, a prosody-informed melody generation module 210 is used during the synthesis stage 203 to generate a melody. The melody generation module 210 uses information about the original song from the pre-processing stage 202 and the syllable onsets as inputs to generate the melody. In addition, the audio-converted text is sent to a musical voice synthesis module 211, which uses the generated melody and the syllable onsets from the pre-processing stage 202 as additional inputs to create melodic speech. The melodic speech and the separated music from the pre-processing stage 202 are combined as a musically integrated speech notification during the output stage 204.

To improve user satisfaction, the system 100 considers the intelligibility of the musically integrated speech notification, rather than providing the most seamless integration. Specifically, two factors affect the intelligibility of musical notifications: (1) the compatibility of the melodic rhythm and the natural spoken rhythm (prosody) of the text transcripts, and (2) the performance of singing voice synthesis (SVS) systems. To improve rhythmic compatibility, the system 100 first estimates the natural spoken rhythm of the text using text-to-speech and then generates a new melody that is close to this rhythm but also compatible with the surrounding musical context.

Further, state-of-the-art SVS systems often produce unintelligible output, even given pairs of melody and text with high rhythmic compatibility (such as the original melody and lyrics). To synthesize singing with higher intelligibility than existing SVS systems, the system 100 modifies outputs from text-to-speech systems to sound more musical (at the cost of naturalness). Accordingly, the system 100 modifies the output of text-to-speech systems to conform to the generated melody using signal processing, sacrificing the naturalness of SVS systems in favor of intelligibility. As a result, the system 100 generates a new melody based on the constraints of both user music context (tempo, harmony) and text context (prosody, syllables), inpainting a new melody that stylistically fits the current song and the message, resulting in better musical integration and better intelligibility. Using computer speech recognition as a proxy for human intelligibility, the TTS-based system 100 achieves higher intelligibility than one based on SVS.

### Input Pre-Processing

By way of further detail of the system 100 described in FIG. 1, input module 208 first receives user music and notification text. Next, the system 100 requires pre-processing 202 of the user music and notification text to extract essential information for melody generation and voice modification at stage 203. The system 100 assumes access to a symbolic representation of the listener's music, including melody notes, chords, and the click track. This information can be retrieved by the pre-processing module 209 from a database (such as Hooktheory's THEORYTAB), which contains manually labeled annotations for thousands of songs, or automatically transcribed from audio. If access to this information is not available, the system 100 can generate the symbolic representation.

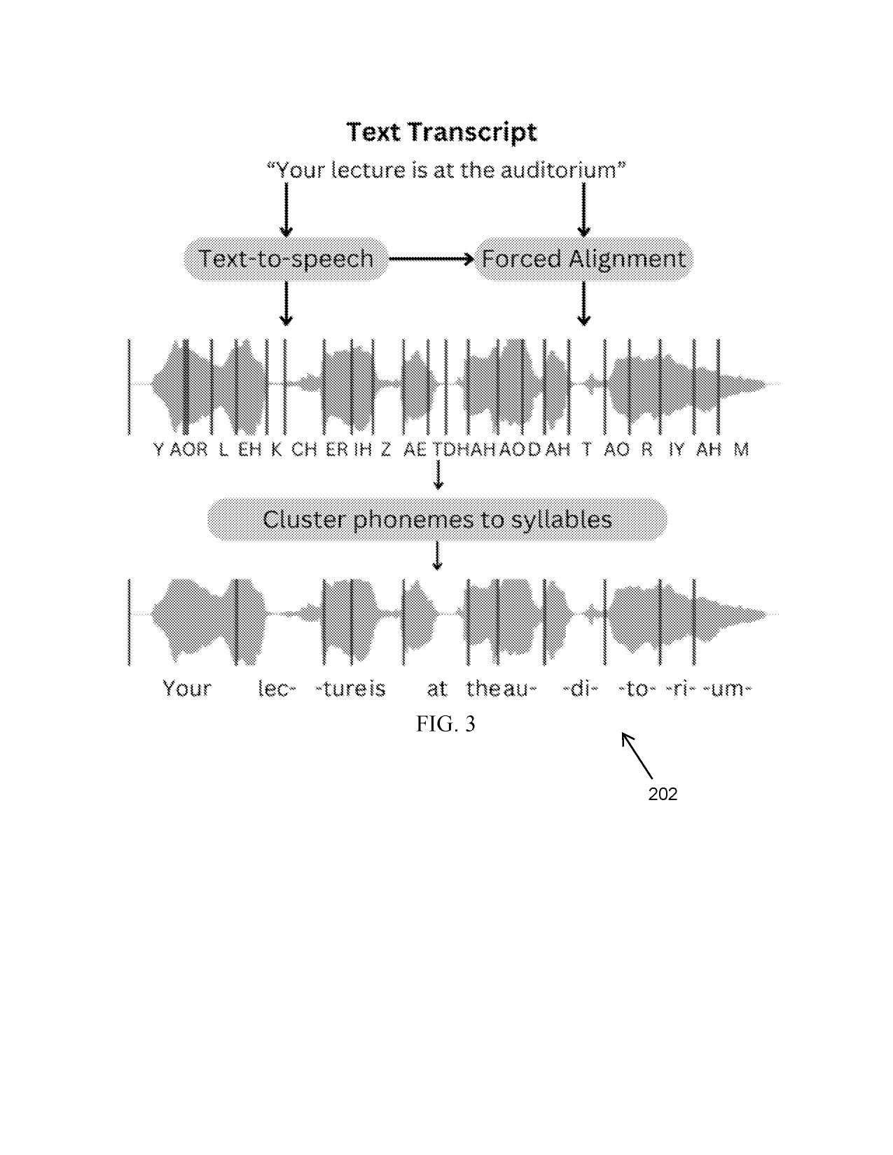

Again, to ensure intelligibility, the system 100 modifies audio outputs of text-to-speech (TTS) systems to create a singing voice synthesis system with high intelligibility. The process involves synthesizing the text as speech audio, estimating the onset time of phonemes, and grouping phonemes into syllables. By way of example, from an input text notification to the system 100, an off-the-shelf TTS system is used to synthesize the text as speech audio. Then, the speech audio and text transcript is input into an off-the-shelf forced alignment system to estimate the onset time of phonemes in audio. Finally, the phonemes are grouped into syllables by filtering through vowels, ensuring that only one vowel was present in each cluster of phonemes, yielding an ascending list of syllable timestamps [t 1, …, t L]. Here, L is the number of syllables in the original text transcript, and t i is the estimated onset time of syllable i. To remove initial silence, the system 100 can shift all timestamps and the audio by a constant amount of time, such that t 1 = 0. The list of syllable timestamps will later be used in both melody generation and voice modification steps. FIG. 3 shows the details of the pre-processing stage 202. As shown in FIG. 3, the system 100 is able to estimate musically relevant prosody information by estimating the onset times for each syllable.

### Generating New Melodies

At stage 203, the system 100 generates new melodies that fit both the detected or retrieved musical context and the natural spoken rhythm of the notification text. There may be some parts of the original melody that are not suitable for the text. Hence, to produce natural-sounding results, the system 100 may generate melodies with awareness of both the musical context and the notification text.

The system 100 is based on the Anticipatory Music Transformer, a large language model capable of symbolic music generation. This model used in the system 100 generates notes in the middle of an existing sequence, considering both past and future notes. To do this, the model considers for each note its absolute start time, duration, instrument category, and musical pitch. The model is a probability distribution over a sequence of notes, given a disjoint sequence of notes. This model facilitates versatile control for music generation, allowing for generating notes from any other sequence of notes (e.g., generating melody from harmony, or generating the past from the future). The model is fine-tuned on a dataset of melody, harmony, and click tracks derived from the music context dataset. Specifically, when generating the melody in the selected span in the middle of a melody, the model will be conditioned on all notes from all instruments in the past, as well as all notes from all instruments up to a period of time into the future.

As a result, the model is capable of generating new context-aware melodies at arbitrary locations in time, creating a flexible system 100 that could generate as soon as possible for higher-urgency notifications, or wait until a more appropriate musical moment for lower-urgency notifications. To choose a musically-appropriate moment, the system 100 starts at the down-beat of the third measure, and generates a new melody up to two measures in length.

Given the fine-tuned model and target span, the system 100 can generate a new melody by sampling from the modeled distribution, using the interference algorithm from the Anticipatory Music Transformer. As melismatic singing (i.e., stretching syllables to matcha melody) is less intelligible, in one embodiment, the system 100 may match one syllable to each not to improve intelligibility. To ensure that a sufficient number of notes are generated to convey the text transcript, the system 100 rejects any samples where the number of notes is less than the number of syllables.

It is generally unlikely that an arbitrary melody pairs naturally with arbitrary text, even if the number of notes in the melody is equivalent to the number of syllables in the text. And forcing text to be synthesized to an arbitrary melody tended to jeopardize intelligibility. Consequently, during the synthesis stage 203, the system 100 generates melodies that are aware of the natural prosody of the text transcript.

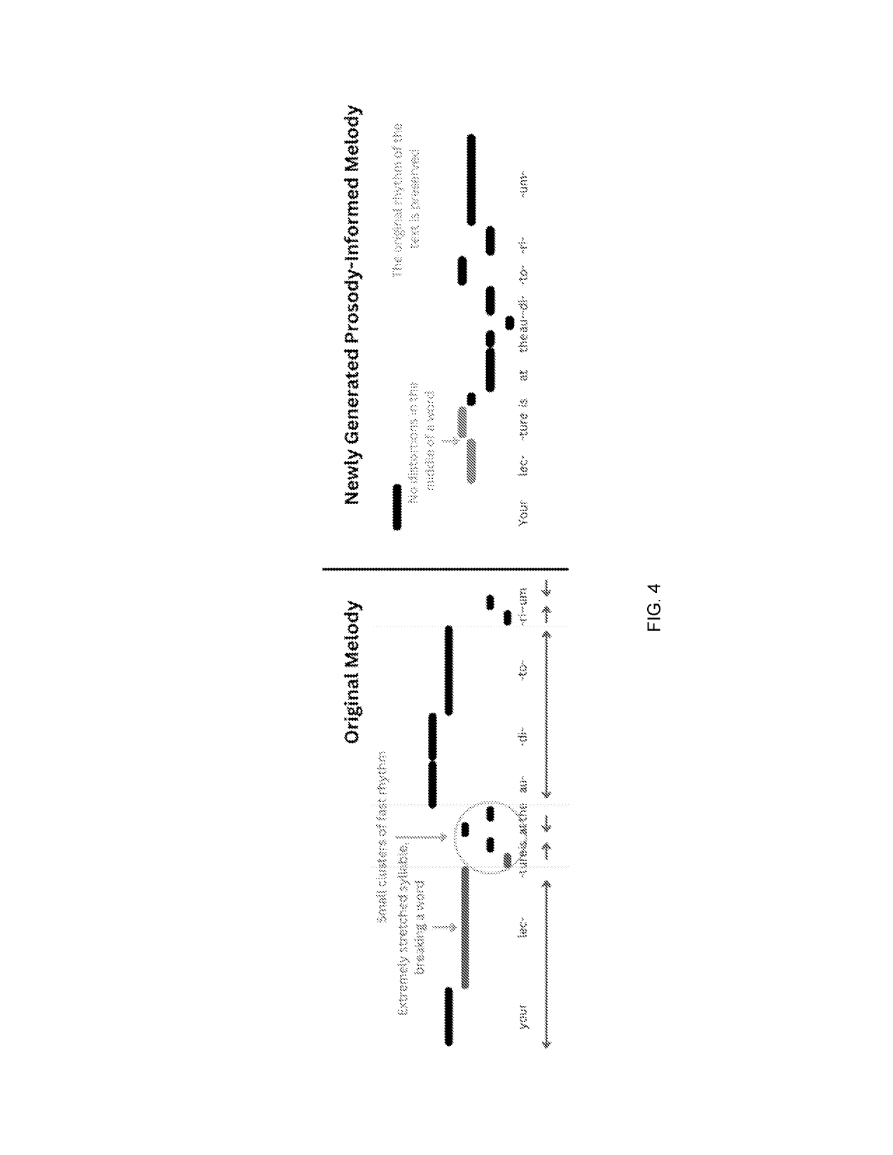

To accomplish this, the system 100 attempts to constrain the model to generate a new melody that has one note for each of L syllables in the text notification. One approach involves first uniformly stretching the original timings of the synthesized speed. For example, the first syllable is mapped to the downbeat of the third measure and the last syllable will occur not later than the fourth measure. FIG. 4 shows the process of stretching the original timings. As shown on the left-side of FIG. 4, when mapping a text transcript to an arbitrary melody, the natural rhythm of the text is broken. Stretching certain syllables for extended durations and compressing some into a short span of time. On the right-side of FIG. 4, the generated melody is tailored to the prosody of the text, minimizing any distortions and maintaining the natural flow of speech.

Because the prosody (here, syllable timings) produced by the TTS system offers a set of timings under which the text is known to sound natural, the system 100 can constrain the notes of the generated melody to be within a certain amount of time of the original prosody. A tolerance factor of one sixteenth note can be used to ensure that the syllable timings of the generated melody are close to the original ones while giving the model some flexibility to make the timings a bit more musically rhythmic.

The system 100 defines the prosody-aware generation of melodies as sampling from a model with two inference-time constraints that respectively adjust the note start and the note duration of melody note I with respect to syllable onset time. This setup ensures that the system 100 generates the same number of notes as syllables L, but does not ensure that generated melody notes are non-overlapping. Accordingly, after the system 100 has sampled the new melody, it is postprocessed to set the duration.

### Musical Voice Synthesis

After prosody-informed melody generation, the musical voice synthesis module 211 modifies TTS outputs to match the pitch and duration of a melody. The system 100 uses the same TTS output used to extract natural prosody onset timings and uses the syllable onset timings extracted to further modify the speech signal. After obtaining the start times of each syllable in a given speech audio clip, the system 100 remaps the pitch and duration of each syllable so that they match the generated melody. This approach improves intelligibility over direct singing voice synthesis.

To achieve this remapping, the system 100 can use a digital signal processing technique known as Time-Domain Pitch Synchronous Overlap and Add (TD-PSOLA). This technique operates by taking as input the original audio, a list of onsets present in the original audio, a corresponding list of target onsets intended for time stretching the audio, and a list of fundamental pitches intended for pitch shifting the audio. It then processes this input data to generate a modified version of the audio. In this altered version, both pitch and duration are adjusted to align with the specified input lists.

Due to a hard constraint on the fundamental pitch, the resulting pitch-shifted speech audio may resemble the outputs of commercial vocal pitch-correction software, such as Autotune. However, the system 100 differs from these tools with the addition of syllable segmentation and automatic mapping of the segmented syllables to an output for use in the user’s music.

### Integration into music

The final stage 204 involves integrating the musical notification into the user's current music at the target location. For target locations without vocals, the output module 212 overlays the speech output and slightly decreases the volume of the track. Unlike traditional notifications, the system 100 only slightly attenuates the music volume so that the overall amplitude does not distort or clip when the musical notification is mixed in. For locations with vocal content, it separates the audio into vocals and instrumental accompaniment, replaces the original vocals with the musical notification, and slightly attenuates the instrumental accompaniment.

Using one example embodiment, the system 100 was tested with end users, in which twelve participants experienced speech messages integrated into popular songs using the system 100, as well as a baseline of non-musical text-to-speech outputs. The users’ preferences were analyzed via subjective ratings and qualitative comments. During this trial, participants were asked to perform everyday work on their own personal laptops while sitting in a typical open space office. At the same time, they listened to eight songs in total, each of which contained one spoken notification created using the two separate methods. As a baseline, voice notifications were delivered using Google's text-to-speech system. For the musically modified speed condition, we used a combination of prosody-constrained melody generation, Pitched TTS, and singing voice conversion.

While the majority of songs on the top songs list were pop and dance music, the trial included wide coverage of genre (e.g., nu-metal, retro chiptune, classical, psychedelic jazz), key (9 represented), year (1680 - 2017), tempo (82-169 BPM, M = 116.4, and SD = 24.16), and the selected section for integration (5 Verse, 3 Chorus, 2 Pre-chorus). The trial controlled the timing of the experiment by trimming songs (gradual fade out) to be around 3 minutes or less in duration. All songs were embedded with exactly one notification, at the 3rd measure of the specified section of integration. Non-modified speech is integrated at the same time as their counterparts but has a randomized offset applied to more accurately represent notifications not entering on downbeats. In this embodiment, a SVC model takes the pitched TTS as input and outputs a voice message that is similar in melody but aims to be more natural in timbre.

While performing their personal tasks, participants experienced all eight songs with embedded notifications. Whenever they encountered a notification, they were asked to transcribe the message on a separate computer. At the end of a four song block, participants were asked to subjectively rate the notifications for noticeability (“I immediately noticed the message”), clarity (“I clearly understood the message”), harmonicity (“The message fits well with the current music”), intrusiveness (“The message felt intrusive to my music listening experience”), enjoyment (“The message was presented in a delightful way”), and overall user experience (“Overall, my experience as a user was good”); all on a scale from 1 (strongly disagree) to 7 (strongly agree).

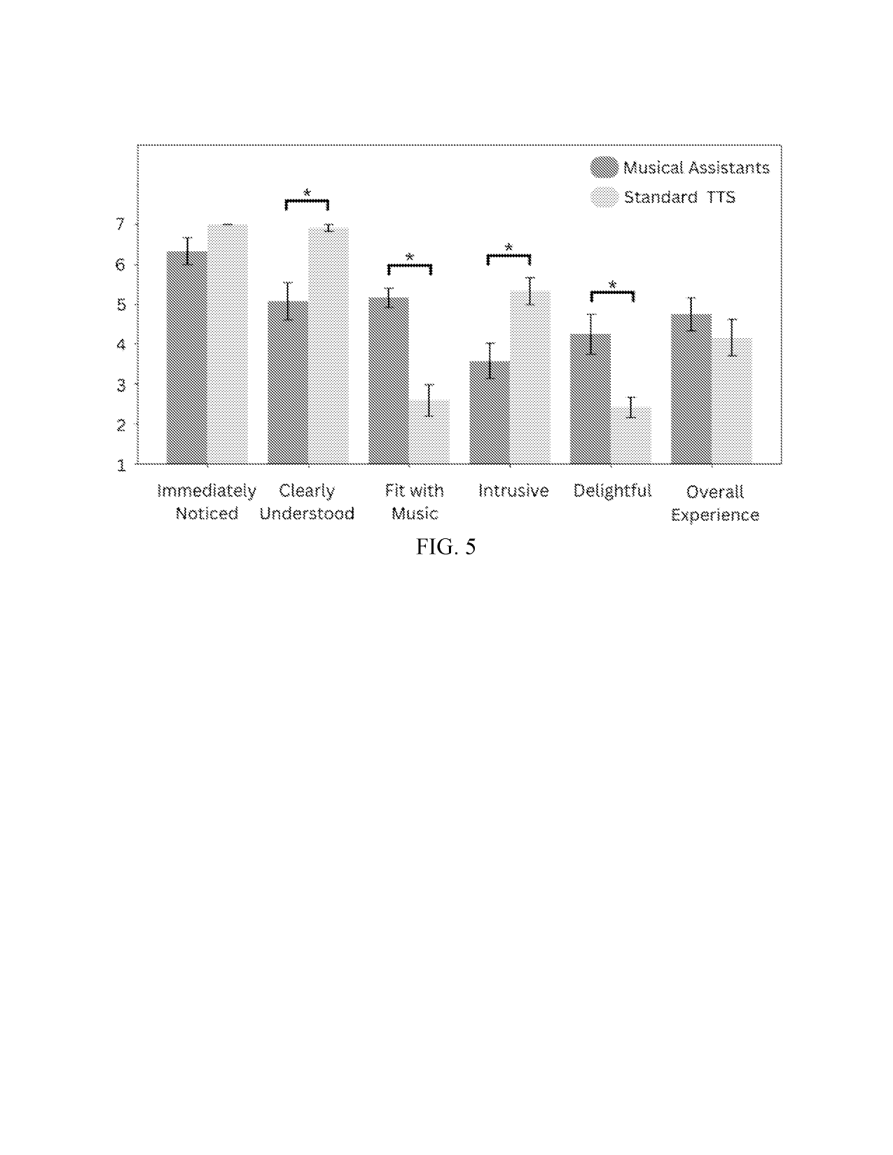

The results of the trial are depicted in FIG. 5. All participants could clearly distinguish between conventional speech messages and the modified musical speech messages. Participants described the baseline condition as being similar to regular TTS, or commercial voice assistants like Apple SIRI. Participants described the system 100 as matching the music in terms of rhythm and pitch (other terms used: beat, key, melody, pace, flow, etc.), singing over the music, and some specifically mentioned the resemblance with autotune (n = 3).Most participants found the baseline condition to be disruptive to their music listening experience and that the modified version blends better with music, making it less intrusive (n = 11). Many participants found the musical voice to also be distracting as its vocal timbre did not match the style of the music, but still less distracting than cutting out the music (n = 7). Better blend, however, may also entail additional mental processing to understand the information. When asked what they value in music voice assistants, participants prioritized clarity (n = 10) and continuity (n = 8). They want clear and distinct notifications that blend seamlessly with music to minimize distractions.

In other embodiments, different performance characteristics of the system 100 can be prioritized, such as selecting optimal moments for notification delivery. For example, rather than interrupting a high-energy chorus, the system 100 can be tuned to identify sections with less action and more space, potentially as a function of notification urgency. Exploring suitable modes and opportune moments for integration on a genre-by-genre or song-by-song basis could further enhance the seamless integration of speech notifications.

When used in this specification and claims, the terms "comprises" and "comprising" and variations thereof mean that the specified features, steps, or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure. Although certain example embodiments of the invention have been described, the scope of the appended claims is not intended to be limited solely to these embodiments. The claims are to be construed literally, purposively, and/or to encompass equivalents.

What is claimed is:

1. A system for providing musical notifications comprising:
an input module configured to receive a text-based notification and user music;
a pre-processing module configured to separate the user music into vocals and musical accompaniment and to convert the notification into speech;
a synthesis module configured to generate a melody based on the notification and user music, and to create melodic speech by mapping syllables of the notification to the generated melody; and
an output module configured to integrate the melodic speech and the generated melody into the user music, creating a musically integrated speech notification.

2. The system of claim 1, wherein the pre-processing module further comprises:
a music information component configured to identify information comprising at least one of melody, chords, beats, and general structure of the user music.

3. The system of claim 1, wherein the pre-processing module includes a text-to-speech system to convert the notification into speech.

4. The system of claim 2, wherein the music information component retrieves the information from a database and the information further comprises a click track.

5. The system of claim 2, wherein the music information component generates the information based on the user music.

6. The system of claim 1, wherein the synthesis module further comprises:
a prosody-informed melody generation component configured to create the generated melody based on a prosody of the text-based notification and the information related to the user music; and
a musical voice synthesis component configured to create the melodic speech by mapping syllables of the speech to the generated melody.

7. The system of claim 6, wherein the prosody of the text-based notification comprises a spoken rhythm of the notification.

8. The system of claim 6, wherein the melodic speech conforms to the generated melody with increased intelligibility compared to a speech generated by a singing voice synthesis system.

9. The system of claim 6, wherein syllables are marked by identifying estimating an onset time of phonemes and grouping the phonemes into syllables.

10. The system of claim 1, wherein the generated melody can be inserted at an arbitrary location in time of the user music.

11. The system of claim 6, wherein the generated melody has one note for each syllable of the melodic speech.

12. The system of claim 6, wherein a pitch and duration of each syllable in the melodic speech is remapped to match the generated melody.

13. The system of claim 1, wherein the output module further comprises:
a component configured to overlay the melodic speech onto the user music by slightly decreasing a volume of the user music.

14. The system of claim 13, further comprising:
a component configured to replace original vocals in the user music with the melodic speech.

15. A method for providing musical notifications, comprising:
receiving notification text and user music;
separating the user music into vocals and instrumental accompaniment;
converting the notification text into a spoken message;
generating a melody based on the notification text and user music;
creating melodic speech by mapping syllables of the notification text to the generated melody; and
integrating the melodic speech into the user music, resulting in a musically integrated speech notification.

16. The method of claim 15, further comprising:
identifying information comprising at least one of melody, chords, beats, and general structure of the user music.

17. The method of claim 15, further comprising:
generating the melody that matches a prosody of the notification text; and
creating the melodic speech by mapping syllables of the notification text to the generated melody.

18. The method of claim 15, further comprising:
overlaying the melodic speech onto the user music by slightly decreasing the volume of the user music; and
replacing original vocals in the user music with the melodic speech.
